(19) United States
(12) Patent Application Publication
(10) Pub. No.: US 2009/0095059 A1
(43) Pub. Date: Apr. 16, 2009

(54) Pressure sensor and structure for attachment of pressure sensor

(75) Inventors: Hiroshige Matsui, Nukata-gun (JP); Yasuaki Makino, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/219,781

(22) Filed: Jul. 29, 2008

(30) Foreign Application Priority Data
Oct. 15, 2007 (JP) 2007-268132

(51) Int. Cl. G01M 15/08; G01L 7/00

(52) U.S. Cl. 73/114.18; 73/756

(57) ABSTRACT

A pressure sensor for use in an engine by installation of the pressure sensor into an installation hole of an engine head is provided. The pressure sensor includes: a body having a first end; a pressure receiving diaphragm disposed in the first end; a sealing surface disposed on the side surface of the body; and an expansion member, which is disposed on the side surface of the body so that, with respect to the first end of the body, the expansion member is located closer than the sealing surface. When heat is generated by an engine operation after the installation of the first end of the body into the installation hole, the expansion member expands due to the heat to fill in a space between an inner surface of the installation hole and a side surface of the body.

### CROSS REFERENCE TO RELATED APPLICATION

The present application is based on Japanese Patent Application No. 2007-268132 filed on Oct. 15 2007, the disclosure of which is incorporated herein by reference.

### BACKGROUND OF THE INVENTION

1. Field of the Invention

The present invention relates to a pressure sensor and a structure for attachment of a pressure sensor.

2. Description of Related Art

Patent Document 1 recites a structure for attachment of a pressure sensor to an installation hole of an engine. According to Patent Document 1, the pressure sensor includes a body having a cylindrical shape. The pressure sensor further includes a pressure receiving element, which is disposed at one end of the body. The pressure receiving element includes a pressure receiving diaphragm, a metal case, a metal stem, and a housing. The body has an outer surface, which includes a sealing surface located closer to the other end of the body than the one end.

More specifically, according to Patent Document 1, the pressure sensor includes a seal member. When the one end of the pressure sensor is installed into the installation hole of the engine, the sealing surface contacts an inner surface of the installation hole. In the above case, the seal member can seals a space defined by the outer surface of the body and the inner surface of the installation hole, which face each other. The sealed space is located between the sealing surface and the one end of the body. Due to the above sealing member, a deposit from a combustion chamber is effectively prevented from entering a gap between the engine and a part of the body, the gap extending toward the combustion chamber from the sealing surface.

Patent Document 1: JP-A-2007-187609

According to the above technique, when the pressure sensor is installed into the engine, the pressure sensor and the engine form a space extending between the sealing surface and a head of the pressure sensor. Combustion heat in the engine can immerse the space and causes deformation of the diaphragm, the metal case, and the stem. The deformation due to the combustion heat influences the sensor output and becomes source of error in the sensor output.

### SUMMARY OF THE INVENTION

In view of the above-described difficulty, it is an object of the present invention to provide a pressure sensor and a structure for attachment of a pressure sensor.

According to a first aspect of the present invention, a pressure sensor for use in an engine by installation of the pressure sensor into an installation hole of an engine head of an engine is provided. The installation hole is commutated with a combustion chamber of the engine head. The pressure sensor includes a body. The body has a tubular shape, has a first end and a second end, and has a side surface. The pressure sensor further includes a pressure receiving diaphragm disposed in the first end of the body. The pressure sensor further includes a sealing surface, which is disposed on the side surface of the body so that the sealing surface is located closer to the second end than the first end of the body. The sealing surface can seal the combustion chamber by contacting an inner surface of the installation hole when the first end of the body is installed into the installation hole. The pressure receiving diaphragm receives pressure in the combustion chamber when the first end of the body is installed into the installation hole. The pressure sensor further includes an expansion member, which is disposed on the side surface of the body so that, with respect to the first end of the body, the expansion member is located closer than the sealing surface. The expansion member expands due to a first heat to fill in a space between the inner surface of the installation hole and the side surface of the body, so that the expansion member surrounds an axis connecting between the first end and the second end, and wherein the first heat is generated in the combustion chamber by an engine operation after the first end of the body is installed into the installation hole.

According to the above pressure sensor, when combustion takes place in the combustion chamber, it is possible to restrict immersion of flame into the space since the space is filled with the expansion member. Thereby, the first end of the body does not substantially deform due to combustion heat. It is possible to reduce influence on the combustion heat on the side surface of the body on a first end side. Therefore, it is possible to provide the pressure sensor with improvement on error in a sensor output.

According to a second aspect of the present invention, a structure for attachment of a pressure sensor to an installation hole of an engine head of an engine is provided. The installation hole is communicated with a combustion chamber of the engine head. The pressure sensor includes a body having a tubular shape, having a first end and a second end, and having a side surface. The first end of the body is installed into the installation hole. The pressure sensor further includes a pressure receiving diaphragm disposed in the first end of the body. The pressure receiving diaphragm receives pressure in the combustion chamber. The pressure sensor further includes a sealing surface, which is disposed on the side surface of the body so that the sealing surface is located closer to the second end than the first end of the body. The sealing surface seals the combustion chamber by contacting an inner surface of the installation hole. The structure for attachment includes an expansion member, which is disposed between the side surface of the body and the inner surface of the installation hole. The expansion member expands due to a first heat and fills in a space between the inner surface of the installation hole and the side surface of the body, so that the expansion member surrounds an axis connecting between the first end and the second end of the body. The first heat is generated in the combustion chamber by an engine operation after the first end of the body is installed into the installation hole.

According to the above structure, when combustion takes place in the combustion chamber, it is possible to restrict immersion of flame into the space since the space is filled with the expansion member. Thereby, the first end of the body does not substantially deform due to combustion heat. It is possible to reduce influence on the combustion heat on the side surface of the body on a first end side. Therefore, it is possible to provide the pressure sensor with improvement on error in a sensor output.

According to a third aspect of the present invention, a structure for attachment of a pressure sensor to an installation hole of an engine is provided. The structure includes an expansion member, which is disposed between a side surface of the pressure sensor and an inner surface of the installation hole. The expansion member expands in response to an engine operation performed for the first time after the pressure sensor is installed into the installation hole of the engine. The expansion member fills in a space between the inner surface of the installation hole and the side surface of the body after the expansion member expands.

According to the above structure, when combustion takes place in the engine, it is possible to restrict immersion of flame into the space since the space is filled with the expansion member. Thereby, the pressure sensor does not substantially deform due to combustion heat. It is possible to reduce influence of the combustion heat on the pressure sensor. Therefore, it is possible to provide the pressure sensor with improvement on error in a sensor output from the pressure sensor.

### BRIEF DESCRIPTION OF THE DRAWINGS

The above and other objects, features and advantages of the present invention will become more apparent from the following detailed description made with reference to the accompanying drawings. In the drawings:

FIG. 1 is a cross sectional view schematically illustrating a pressure sensor and a structure for attachment of a pressure sensor to an engine head in accordance with a first embodiment;

FIG. 2 is an enlarged cross sectional view schematically illustrating a stem shown in FIG. 1;

FIG. 3 is a cross sectional view schematically illustrating a state where a pressure sensor is installed into the engine head, in accordance with the first embodiment; and

FIG. 4 is a cross sectional view schematically illustrating a state where a pressure sensor is installed into the engine head, in accordance with a second embodiment.

### DETAILED DESCRIPTION OF THE PREFERRED EMBODIMENTS

Embodiments according to the present invention are described below with reference to the accompanying drawings.

### First Embodiment

A pressure sensor and a structure for attachment of the pressure sensor are described below with reference to the accompanying drawings. The pressure sensor can be installed into, for example, an installation hole of an engine head of an engine of an automobile by using a screw. The installed pressure sensor is used for detecting pressure in a combustion chamber (i.e., pressure in a cylinder).

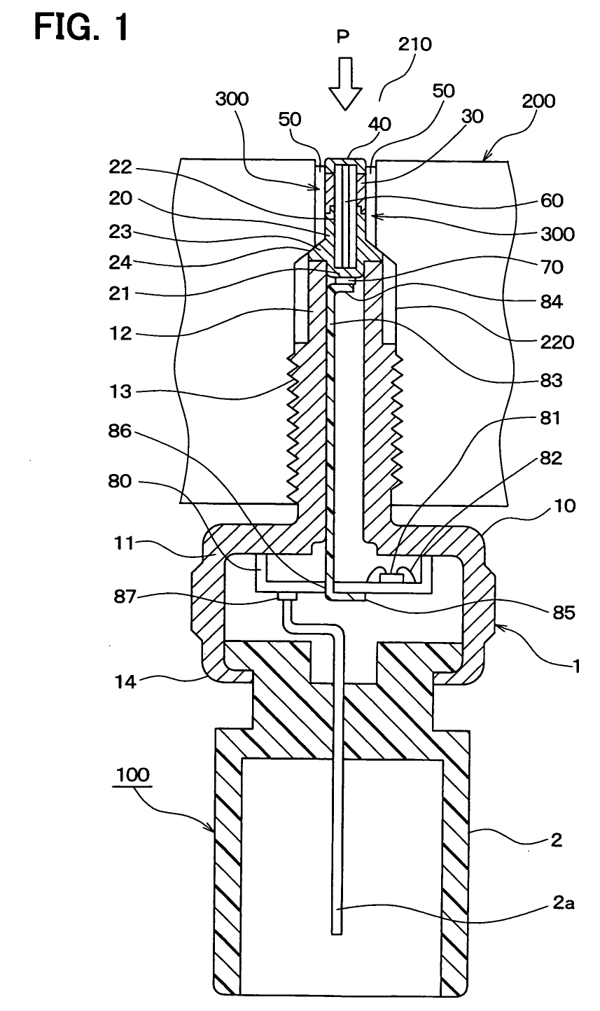

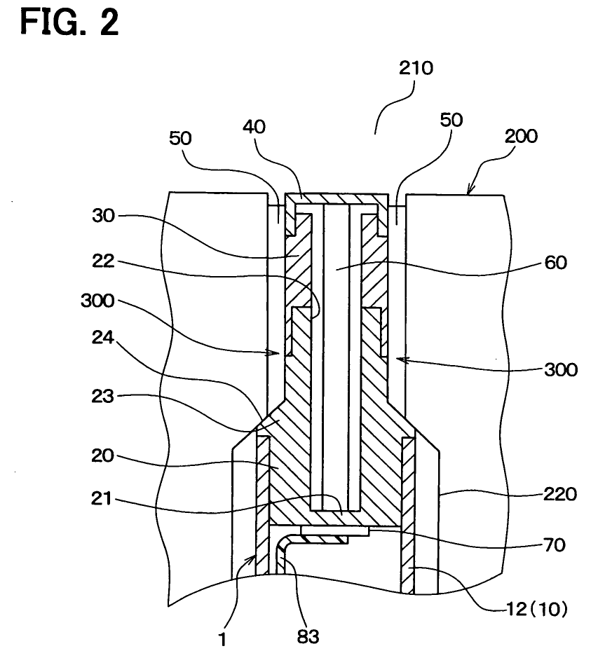

FIG. 1 is a cross sectional view schematically illustrating the pressure sensor 100 and a structure for attachment of the pressure sensor 100 to the engine head 200 in accordance with the present embodiment. FIG. 2 is an enlarged cross sectional view schematically illustrating a stem shown in FIG. 1. In the followings, the pressure sensor 100 and the structure for attachment of the pressure sensor 100 are described below with reference to FIGS. 1 and 2.

As shown in FIG. 1, the pressure sensor includes a body 1 and a connector case 2. The body 1 is a substantially tubular shape. The body 1 has a first end (i.e., one end) and a second end (i.e., the other end). Pressure in a combustion chamber 210 is detected at the first end of the body 1. The connector case 2 is connected to the second end of the body 1. An electrical signal having information on the detected pressure is output from the connector case 2 to an external element.

The body 1 includes a housing 10, a stem 20, a metal case 30, a pressure receiving diaphragm 40, an expansion member 50, a rod 60, a sensor chip 70, and a circuit substrate 80, which may be integrated. The connector case 2 is connected with the housing 10 of the body 1.

The housing 10 includes a housing main part 11 and a pipe part 12. The housing main part 11 has a substantially tubular shape. The pipe part 12 has a substantially narrow tubular shape and is narrower than the housing main part 11. The housing main part 11 and the pipe part 12 are made of metal such as stainless and are formed through cutting and cold forging. The pipe part 12 has a substantially circular tubular (i.e., pipe) shape. The housing main part 11 and the pipe part 12 are integrally formed to provide the housing 10.

Alternatively, the housing main part 11 and the pipe part 12 may be formed separately from each other, and may be connected to each other by, for example, welding, bonding, screwing, crimping, or the like. Alternatively, the pipe part 12 may have a polygonal pipe shape.

The pipe part 12 of the housing 10 has an outer surface, on which a thread part 13 is formed. The thread part 13 can have screw-in connection with the engine head 200 of the engine. The pipe part 12 of the housing 10 is installed into the installation hole (i.e., a screw hole) of the engine head 200, and the pressure sensor 100 is mounted to the engine head 200 by using the thread part 13.

The stem 20 is made of metal and is processed so as to have a substantially tubular shape with a hollow therein. A pressure sensing diaphragm 21 is disposed around one end of an axis of the stem 20. The pressure sensing diaphragm 21 has a substantially sheet shape and is deformable. The other end of the stem 20 has an opening 22.

The stem 20 includes a flange 23, which projects in a direction roughly perpendicular to the outer surface. The flange 23 is located on the outer surface of the stem 20 on a pressure sensing diaphragm 21 side. The flange 23 forms a tapered surface extending toward the pressure sensing diaphragm 21 from a part of the outer surface of the stem 20 on an opening 22 side. The tapered surface can contact the engine head 200, and thereby, provides a sealing surface 24 for sealing the combustion chamber 210.

The sealing surface 24 is disposed on a side surface of the body 1 so as to be located closer to the first end of the body 1 than the second end. When the first end of the body 1 is installed into the installation hole 220 commutated with the combustion chamber 210, the sealing surface 24 tightly contacts the inner surface of the installation hole 220 and seals the combustion chamber 210. The sealing is achieved by metal touch between the sealing surface 24 and the inner surface of the installation hole 220.

The opening 22 of the stem 20 is directed to the combustion chamber 210. One end of the stem 20 on a pressure sensing diaphragm 21 side is installed into an apical portion of the pipe part 12 of the housing 10. The one end of the stem is fixed to the apical portion by welding, bonding, or the like. The stem 20 may alternatively have a polygonal tubular shape.

The metal case 30 is made of metal such as stainless and has a substantially tubular shape having a hollow. One end of the metal case 30 has an opening. The opening of the metal case 30 is inserted into the opening 22 of the stem 20. An overlapping portion between the metal case 30 and the stem 20 are welded and integrated with each other.

The pressure receiving diaphragm 40 is made of metal and has a substantially circular plate shape. The pressure receiving diaphragm 40 is joined with and fixed to the open end of the metal case 30 by welding, brazing or the like. With respect to the metal case 30, the pressure receiving diaphragm 40 is opposite to the stem 20. The opening 22 of the stem 20 is closed by the pressure receiving diaphragm 40 through the metal case 30. The pressure receiving diaphragm 40 faces (i.e., is exposed to) the combustion chamber 210. The pressure receiving diaphragm 40 receives a combustion pressure P (the pressure in the cylinder), and thereby, deforms and has strain therein. The combustion pressure P can be detected at the first end of the body 1.

When the expansion member 50 is placed in a heat bath having temperatures greater than or equal to, for example, 400 degree C., the expansion member 50 expands and the volume of the expansion member 50 increases. The expansion member 50 is disposed on the side surface of the body 1 so that the expansion member 50 is disposed between the first end of the body 1 and the sealing surface 24. The expansion member 50 fills in a space 300 between the inner surface of the installation hole 220 and the side surface of the body 1. The expansion member is disposed all round an axis of the body 1. The axis connects between the first end and the second end of the body (1).

More specifically, the space 300 is defined by the inner surface of the engine head 200, the sealing surface, and a part of the side surface of the body 1. The part of the side surface is located between the sealing surface and the first end of the body 1.

The expansion member 50 can play a role in filling in the space 300 so as to surround the axis of the body 1, and thereby, restricts heat immersion into the space 300. Further, presence of the expansion member 50 reduces a space for heat immersion compared to absence of the expansion member 50. The expansion member 50 reduces an area of the side surface of the body exposed to the combustion heat. It is possible to reduce influence of the combustion heat on the body 1.

It may be preferable that the expansion member 50 fully fills in the space 300 to restrict heat immersion in the space 300. In this case, the influence of the combustion heat on the body 1 may be remarkably small.

The space 300 includes a first space portion and a second space portion. The first space portion is located closer to the second end of the body 1 than the second space portion is. When the combustion chamber is in a combustion state, the expansion member 50 is pushed toward the second end of the body 1. In the above case, when the expansion member 50 fully fills in the first space portion of the space 300, the expansion member 50 can resist the pushing. When whole of the space 300 is fully filled with the expansion member 50, it is possible to increase the resistance to the pushing.

When the expansion member 50 is disposed in the space 300, and when the pressure sensor 100 stores the combustion heat generated in the combustion chamber 210, the stored heat is released through the expansion member 50 to the engine head 200, which is cooled by engine coolant. In the above case, when whole of the space 300 is filled with the expansion member 50, a contact area between the expansion member 50 and the pressure sensor 100 increases, and accordingly, heat release performance increases.

As described below, the expansion member 50 is not in an expanded state before and when the pressure sensor 100 is mounted to the engine head 200. After the pressure sensor 100 is mounted to the engine head 200, the expansion member 50 expands due to heat, which is generated in the combustion chamber 210 when an engine operation starts. Then, the expansion member 50 fills in the space 300 between the side surface of the installation hole 220 and the side surface of the body 1.

The expansion member 50 is made of, for example, carbon material, resin material such as polyimide, or the like. Since the carbon material has a high thermal conductivity, it is possible to increase the heat release performance from the pressure sensor 100 to the engine head 200 through the expansion member 50. The expansion member 50 has, for example, a substantially tape shape, or alternatively, a substantially powder form. The expansion member 50 that has the substantially powder form may be made of a thermally-expandable graphite powder.

The rod 60 transmits the pressure received with the pressure receiving diaphragm 40 to the sensor chip 70. The rod 60 has a substantially rod shape and is disposed in a space, which is formed by the hollow in the stem 20 and the hollow in the metal case 30. That is, the rod 60 is interposed between the pressure receiving diaphragm 40 and the pressure sensing diaphragm 21.

One end of the rod 60 on a stem 20 side contacts the pressure sensing diaphragm 21 under a state where the one end of the rod 60 loads the pressure sensing diaphragm 21. The other end of the rod 60 on a metal case 30 side contacts the pressure receiving diaphragm 40 in a state where the other end of the rod 60 loads the pressure receiving diaphragm 40.

That is, the metal case 30 is welded to the stem 20 under the following state; the pressure P to be detected is not applied to the pressure receiving diaphragm 40; and the pressure sensing diaphragm 21 (i.e., the sensor chip 70) is loaded from the pressure receiving diaphragm 40 through the rod 60. The pressure P is to be applied to the pressure sensing diaphragm 21 through the rod 60 and eventually applied to the sensor chip 70.

The rod 60 is made of, for example, metal such as stainless or ceramic. The rod 60 has a substantially rod shape. Alternatively, the rod 60 may have a substantially spherical shape, a substantially oblate spherical shape, a substantially hourglass shape (i.e., a shape like a cylinder, radii of which increase from a middle portion toward both ends of the cylinder). The rod 60 may be also referred to hereinafter as a pressure transmission member.

The sensor chip 70 outputs an electrical signal, which depends on the applied pressure. The sensor chip 70 is mounted on a surface of the pressure sensing diaphragm 21 by glass welding, the surface being opposite to the surface which the rod 60 contacts. The sensor chip 70 has a strain gauge function. According to the strain gauge function, when the sensor chip 70 is strained by the applied pressure, the sensor chip 70 outputs a signal corresponding to the strain.

The following device may be adopted as the sensor chip 70 having the strain gauge function. The device includes a silicon semiconductor chip formed by semiconductor processing. The semiconductor chip has a bridge circuit composed of, for example, a diffused resistor element.

Operations of the semiconductor chip having the above strain gauge function are, for example, as follows. When pressure deforms the pressure sensing diaphragm 21 of the stem 20, the deformation causes strain in the semiconductor chip accordingly, and the strain changes a resistance. The semiconductor chip converts the change in the resistance into an electrical signal, and outputs the electrical signal. That is, the sensor chip 70 and the pressure sensing diaphragm 21 are configured to deform by the load caused by the pressure P to be detected.

The circuit substrate 80 includes a circuit for processing the electrical signal output from the sensor chip 70. The circuit substrate 80 includes a ceramic base. The circuit substrate 80 is disposed inside the housing main part 11 of the housing 10. More specifically, the circuit substrate 80 is disposed so as to cover an opening of the pipe part 12. A periphery of the circuit substrate 80 is fixed to the housing by, for example, adhesion.

The IC chip 81 is mounted on a part of a surface of the circuit substrate 80 on a pipe part 12 side by bonding. The IC chip 81 includes a circuit for amplifying and adjusting the output from the sensor chip 70. The bonding wire 82 is made of, for example, aluminum (Al), gold (Au) or the like. The bonding wire 82 connects between the IC chip 81 and the circuit substrate 80.

Further, as shown in FIGS. 1 and 2, the circuit substrate 80 is electrically connected with the sensor chip 70 by a flexible printed circuit 83. The flexible printed circuit 83 may includes a base made of polyimide resin. A conductor such as copper (Cu) may be patterned on the base. As shown in FIG. 1, the flexible printed circuit 83 is disposed in the pipe part 12 so as to extend in a longitudinal direction of the pipe part 12. Instead of the flexible printed circuit 83, a lead wire may be alternatively employed.

The flexible printed circuit 83 has a first end part 84 and a second end part 85. The first end part 84 is electrically and mechanically connected with a pad (not shown) formed on a surface of the sensor chip 70 by using, for example, a solder. The first end part 84 of the flexible printed circuit 83 is a connection part for having connection with the sensor chip 70. The flexible printed circuit 83 is bent from the first end part 84, which provides a bent part. A portion of the flexible printed circuit 83 between the first end part 84 and the second end part 85 is disposed in the pipe part 12 to extend toward the circuit substrate 80.

The second end part 85 of the flexible printed circuit 83 is located in the housing main part 11 of the housing 10. The flexible printed circuit 83 extends to the second end thereof through a through-hole formed in the circuit substrate 80. The second end part 85 is disposed on a first surface of the circuit substrate 80, the first surface being opposite to the surface on which IC chip is disposed. The second end part 85 is electrically connected with the first surface of the circuit substrate 80 through, for example, a solder.

The connector case 2 provides a connector for outputting the electrical signal processed in the IC chip 81 to an external element or system. With respect to the housing 10, the connector case 2 is opposite to the first surface of the circuit substrate 80. The connector case 2 is made of resin such as polyphenylene sulfide (PPS). The connector case 2 includes a terminal 2A, which is integrated with the connector case by insert-molding. The terminal 2A provides the connector case 2 with multiple terminal portions, which may include a terminal portion for power source, that for outputting a signal, that for inputting a signal, and the like.

The terminal 2A of the connector case 2 is electrically connected with and the circuit substrate 80 through a spring member 87, which causes a spring contact. The sensor chip 70 is electrically connected with the connector case 2 through the flexible printed circuit 83 and the circuit substrate 80.

As shown in FIG. 1, a crimp part 14 of the housing main part 11 of the housing 10 is crimped on the connector case 2, and thereby, the connector case 2 and the housing 10 are integrated. The terminal 2A is capable of having connection with an external element such as an electronic control unit (ECU) of a vehicle through a line element (not shown), and make it possible to communicate between the pressure sensor 100 and the external element by using a signal.

A method for manufacturing a pressure sensor 100 shown in, for example, FIGS. 1 and 2, is described below. A sensor chip 70, a stem 20 having a pressure sensing diaphragm 21, and a rod 60 are prepared. The sensor chip 70 is joined with a surface of the pressure sensing diaphragm 21 of the stem 20 by glass-welding. A first end part of the flexible printed circuit 83 is connected through a solder to the sensor chip 70 joined with the stem 20.

A second end part 85 of the flexible printed circuit 83 is inserted into an apical portion of a pipe part 12 of the housing 10. The second end part 85 is pull out so that the second end part 85 is disposed inside a housing main part 11 of the housing 10. The stem 20 is joined with the pipe part 12 of the housing 10.

The second end part 85 of the flexible printed circuit 83 is inserted into a through hole 86 of a circuit substrate 80, to which an IC chip 81 is mounted using wire bonding. The second end part 85 of the flexible printed circuit 83 is connected to the circuit substrate 80 using a solder.

The circuit substrate 80 is joined to and fixed to the housing main part 11 of the housing 10. A connector case 2 is installed into the housing main part 11 of the housing 10. The crimp part 14 of the housing 10 is crimped on the connector case 2 so that the connector case 2 is fixed to the housing 10. In the above, a terminal 2A and the circuit substrate 80 are electrically connected to each other though a spring member 87, which provides a spring contact between the terminal 2A and the circuit substrate 80. Through the above processes, the sensor chip 70, the stem 20 and the housing 10 are integrated.

A metal case 30 and a pressure receiving diaphragm 40 are joined and fixed to each other by brazing, welding, or the like. Through the above processes, the metal case 30 and the pressure receiving diaphragm 40 are integrated.

A rod 60 is interposed between the sensor chip 70 and the pressure receiving diaphragm 40, as shown in FIG. 2, and an overlapped portion between the stem 20 and the metal case 30 are welded under the following condition. Through the pressure receiving diaphragm 40 and the rod 60, a predetermined load is applied to the pressure sensing diaphragm 21 of the stem 20 and the sensor chip 70. Through the above processes, the body 1 is formed.

An expansion member 50 is placed around the first end of the body 1. More specifically, the expansion member 50 is placed on a portion of the body 1. The portion of the body 1 includes a part of a side surface of the stem 20, a part of a side surface of the metal case 30 and a part of the pressure receiving diaphragm 40. The portion of the body 1 is to face the inner surface of the installation hole 220 of the engine head 200 when the pressure sensor is attached to the engine head 200.

An expansion member 50 having a substantially tape shape may be applied to the portion of the body 1. Alternatively, an expansion member 50 having a substantially powder form may be coated on the portion of the body 1. When the expansion member 50 has the substantially tape shape or the substantially powder form, such expansion member 50 is easy to be placed on the body 1 since it is sufficient to just apply the expansion member 50 to the portion of the side surface of the body 1. The portion is located closer to the first end of the body 1 than the second end of the body 1.

Since the expansion member 50 is to expand, and since the volume of the expansion member 50 is to increase, the expansion member 50 may alternatively be disposed on the side surface of the stem 20 and the side surface of the metal case 30 only. Alternatively, the expansion member 50 may be disposed on a sealing surface 24 of the stem 20. Through the above processes, it is possible to complete manufacturing the pressure sensor 100 shown in, for example, FIGS. 1 and 2.

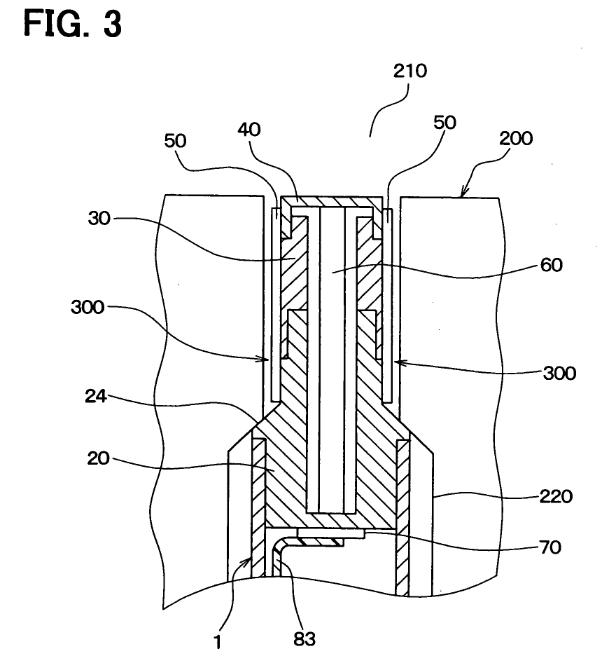

A method for attaching the pressure sensor 100 to the engine head 200 is described below with reference to FIGS. 2 and 3. When the pressure sensor 100 is attached to the engine head 200, an attachment structure of the pressure sensor 100 is provided. In the followings, such attachment structure is also described below with reference to FIGS. 2 and 3. In the followings, the pressure sensor 100 may be the one that is provided according to the above-described manufacturing method. FIG. 3 is an enlarged cross sectional view illustrating the stem 20 of the pressure sensor 100. FIG. 3 also shows a state where the pressure sensor 100 is installed into the installation hole 220 of the engine head 200.

At first, the pressure sensor 100 is installed into the installation hole 220 of the engine head 200 using the thread part 13 of the housing 10. In the above, the sealing surface 24 of the flange 23 of the stem 20 closely contacts the inner surface of the installation hole 220 of the engine head 200. Thereby, the combustion chamber 210 of the engine is closed by metal touch sealing. Through the above manners, the pressure sensor 100 is connected and fixed to the engine head 200.

Before the engine starts combustion, the expansion member 50 does not expand. Accordingly, as shown in FIG. 3, there exists a room in the space 300 between the expansion and the inner surface of the installation hole 220 of the engine head 200.

When the engine starts combustion, heat is generated in the combustion chamber 210. The expansion member 50 expands due to the heat. More specifically, the expansion member 50 expands due to the combustion in the combustion chamber 210 taking place for the first time after the pressure sensor 100 is attached to the engine head 200. Because of the expansion of the expansion member 50, the expansion member 50 fills in the space 300 between the side surface of the body 1 and the inner surface of the installation hole 220 of the engine head 200 so that the expansion member 50 surrounds an axis of the body 1. The axis of the body 1 may connect between the first end of the body and the second end of the body 1.

After the expansion member 50 expands according to the above manner, the expansion member 50 does not substantially contract any more. That is, until the pressure sensor 100 is removed from the engine head 200, the expansion member 50 maintains such a structure that that expansion member 50 fills in the space 300 between the side surface of the body 1 and the inner surface of the installation hole 220 of the engine head 200.

After the pressure sensor 100 is attached to the engine head 200 according to the above manners, the pressure P in the combustion chamber (the pressure in the cylinder) is applied to the pressure sensing diaphragm 21 through the pressure receiving diaphragm 40 and the rod 60, as illustrated as an arrow in FIG. 1. The applied pressure causes deformation of the pressure sensing diaphragm 21 of the stem 20, and the deformation is converted into the electrical signal. Thereby, the pressure is detected. The electrical signal output from the sensor chip 70 is transmitted to the circuit substrate 80 through the flexible printed circuit 83. The electrical signal is processed in the IC chip 81. The terminal 2A outputs the processed electrical signal to the external element.

As described above, the pressure sensor 100 according to the present embodiment has the sealing surface on the side surface of the body 1. Further the expansion member 50 is disposed on the side surface of the body 1 so that expansion member 50 is located between the sealing surface 24 and the pressure receiving diaphragm 40. The pressure sensor 100 can be attached to the engine head 200. When the pressure sensor 100 is attached, the expansion member 50 can expands due to the heat generated by the first time combustion in the combustion chamber 210, and thereby, the expansion member 50 can fills in the space 300 between the inner wall of the installation hole 220 of the engine head and the side surface of the body 1.

According to the above configuration, it is possible to effectively restrict flame from entering the space 300. Thus, the combustion heat does not substantially cause deformation of the body 1 on a first end side. It is possible to reduce influence of the heat on the side surface of the body 1. It is possible to reduce error in a sensor output.

In the above case, when the expansion member 50 fills in whole of the space 300, the heat in the pressure sensor 100 is more effectively released to the engine head 200 through the expansion member 50. Thereby, it is possible to reduce error in the sensor output.

Further, in order to attach the pressure sensor to the engine head 200, it is sufficient to prepare the pressure sensor 100 having the expansion member 50. Therefore, it is not necessary to take into account a structure change and a structure constraint of the engine head 200, and also, it is not necessary to taken into account a structure change and a structure constraint of the pressure sensor 100. Therefore, it is possible to facilitate attaching the pressure sensor 100 to the engine head 200.

### Second Embodiment

According to the first embodiment, one example of the pressure sensor 100 is described, which includes the expansion member 50 disposed on the side surface of the body 1 of the pressure sensor 100. Further, according to the first embodiment, one example of the structure for attachment of the pressure sensor to the engine head 200 is described. According to the present embodiment, one example is described below where the expansion member 50 is disposed on the inner surface of the installation hole 220 of the engine head 200.

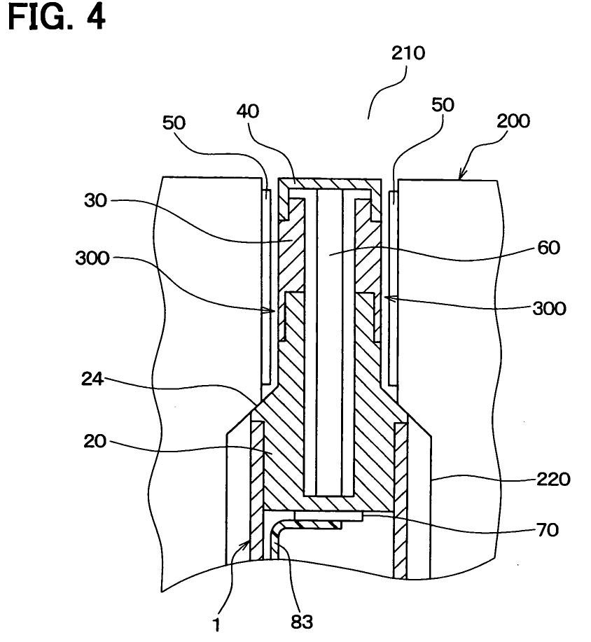

FIG. 4 is a cross sectional view schematically illustrating a state where a pressure sensor is installed into the engine head. In FIG. 4, elements around the stem 20 are illustrated. As shown in FIG. 4, when the pressure sensor 100 is attached to the engine head 200, the expansion member 50 is disposed on a portion of the inner surface of the installation hole 220. The portion of the installation hole 220 faces the side surface of the stem 20, the side surface of the metal case 30, and the pressure receiving diaphragm 40. Like the expansion member according to the first embodiment, the expansion member 50 according to the present embodiment has a substantially tape shape, a substantially powder form, or the like.

In the above structure, when the engine starts the combustion in the combustion chamber 210, the expansion member 50 expands and fills in the space 300. Then, the structure shown in FIG. 2 is provided.

When the expansion member 50 is disposed in the installation hole of the engine head 200 in accordance with the above manners, it may be possible to employ a general-purpose pressure sensor. Also, it is not necessary to take into account a change in a structure of the engine head 200. The structure shown in FIG. 2 is easily achieved.

### Third Embodiment

According to the first embodiment, the expansion member 50 is disposed on the pressure sensor 100. According to the second embodiment, the expansion member 50 is disposed in the installation hole of the engine head 200. According to the present embodiment, after the pressure sensor 100 is installed into the engine head 200, the expansion member 50 is injected into the space 300 between the side surface of the body 1 and the inner surface of the installation hole 220, so that the structure shown in FIG. 2 is provided.

One example of an injection method is as follows. When the expansion member 50 has a substantially powder form, the expansion member 50 is sprayed into the space 300 by using a spray, and thereby, the expansion member 50 is placed in the space 300. Alternatively, when the expansion member 50 is gel in form, the expansion member 50 may be coated and injected into the space 300 by using a dispenser.

As described above, the expansion member expands due to the combustion in the engine. Thus, the expansion member 50 is not necessary to fills in whole of the space 300 at a time when the expansion member 50 is injected. The above-described injection method is merely one example. An alternative injection method may be adopted.

As described above, it is also possible to place the expansion member 50 in the space 300 after the pressure sensor 100 is installed into the engine head 200. According to the above manners, it is not necessary to prepare the pressure sensor 100 having the expansion member 50. Also, it is not necessary to prepare the engine head 200 in which the expansion member is disposed. It is sufficient to prepare the expansion member 50 only.

### Other Embodiments

The structure and configuration associated with the pressure sensors 100 according to the above embodiments are examples. The structure and configuration may have alternative configurations.

In the above embodiments, the expansion member 50 is fully disposed in, for example, at least a portion of the space 300 on a second end side. Alternatively, the expansion member 50 may be partially disposed. In other words, there may exist room between the expansion member 50 and the sealing surface 24. More specifically, the expansion member 50 may be disposed in the space 300 so that there is a gap among the sealing surface 24, the side surface of the body 1, the inner surface of the installation hole 220, and the expansion member 50. The expansion member 50 may not fill in whole of the space 300.

While the invention has been described with reference to preferred embodiments thereof, it is to be understood that the invention is not limited to the preferred embodiments and construction. The invention is intended to cover various modification and equivalent arrangements. In addition, while the various combinations and configurations, which are preferred, other combinations and configurations, including more, less or only a single element, are also within the spirit and scope of the invention.

What is claimed is:

1. A pressure sensor for use in an engine by installation of the pressure sensor into an installation hole of an engine head of the engine, the installation hole being commutated with a combustion chamber of the engine head, the pressure sensor comprising:
a body having a tubular shape, having a first end and a second end, and having a side surface;
a pressure receiving diaphragm disposed at the first end of the body;
a sealing surface disposed on the side surface of the body so that the sealing surface is located closer to the second end than the first end of the body, wherein the sealing surface seals the combustion chamber by contacting an inner surface of the installation hole when the first end of the body is installed into the installation hole, wherein the pressure receiving diaphragm receives pressure in the combustion chamber when the first end of the body is installed into the installation hole; and
an expansion member disposed on the side surface of the body so that, with respect to the first end of the body, the expansion member is located closer than the sealing surface,
wherein the expansion member expands due to a first heat to fill in a space between the inner surface of the installation hole and the side surface of the body, so that the expansion member surrounds an axis of the body interconnecting between the first end and the second end,
wherein the first heat is generated in the combustion chamber by an engine operation after the first end of the body is installed into the installation hole.

2. The pressure sensor according to claim 1, wherein:
the space includes a first space portion and a second space portion;
the first space portion is located closer to the second end of the body than the second space portion is; and
the expansion member fills in the first space portion of the space.

3. The pressure sensor according to claim 2, wherein
the expansion member fills in whole of the space.

4. The pressure sensor according to claim 1, wherein
the expansion member is made of carbon material.

5. The pressure sensor according to claim 1, wherein
the expansion member is made of resin.

6. The pressure sensor according to claim 1, wherein
the expansion member has a substantially tape shape.

7. The pressure sensor according to claim 1, wherein
the expansion member has a substantially powder form.

8. A structure for attachment of a pressure sensor to an installation hole of an engine head of an engine, the installation hole being communicated with a combustion chamber of the engine head, wherein the pressure sensor includes a body having a tubular shape, having a first end and a second end, and having a side surface, wherein the first end of the body is installed into the installation hole, wherein the pressure sensor further includes a pressure receiving diaphragm disposed at the first end of the body, wherein the pressure receiving diaphragm receives pressure in the combustion chamber, wherein the pressure sensor further includes a sealing surface disposed on the side surface of the body so that the sealing surface is located closer to the second end than the first end of the body, wherein the sealing surface seals the combustion chamber by contacting an inner surface of the installation hole, the structure for attachment comprising:
an expansion member disposed between the side surface of the body and the inner surface of the installation hole, wherein
the expansion member expands due to a first heat and fills in a space between the inner surface of the installation hole and the side surface of the body, so that the expansion member surrounds an axis connecting between the first end and the second end of the body, wherein
the first heat is generated in the combustion chamber by an engine operation after the first end of the body is installed into the installation hole.

9. The structure for attachment according to claim 8, wherein
the space includes a first space portion and a second space portion;
the first space portion is located closer to the second end of the body than the second space portion is; and
the expansion member fills in the first space portion of the space.

10. The structure for attachment according to claim 9, wherein
the expansion member fills in whole of the space.

11. The structure for attachment according to claim 8, wherein
the expansion member is disposed on the side surface of the body.

12. The structure for attachment according to claim 8, wherein
the expansion member is disposed on the inner surface of the installation hole before the engine operation starts.

13. The structure for attachment according to claim 8, wherein
the expansion member is injected into the space after the first end of the body is installed into the installation hole.

14. The structure for attachment according to claim 8, wherein
the expansion member is made of carbon material.

15. The structure for attachment according to claim 8, wherein
the expansion member is made of resin.

16. The structure for attachment according to claim 8, wherein
the expansion member has a substantially tape shape.

17. The structure for attachment according to claim 8, wherein
the expansion member has a substantially powder form.

18. The structure for attachment according to claim 8, wherein
the expansion member has a substantially gel form.

19. A structure for attachment of a pressure sensor to an installation hole of an engine, comprising:
an expansion member disposed between a side surface of the pressure sensor and an inner surface of the installation hole, wherein
the expansion member expands in response to an engine operation performed for the first time after the pressure sensor is installed into the installation hole of the engine, wherein
the expansion member fills in a space between the inner surface of the installation hole and the side surface of the body after the expansion member expands.
